(19) United States
(12) Patent Application Publication
(10) Pub. No.: US 2009/0055235 A1
(43) Pub. Date: Feb. 26, 2009

(54) SYSTEM AND METHOD FOR ASSISTED HANDLING OF CASCADING MEETING CHANGES

(75) Inventors: Tolga Oral, Winchester, MA (US); Andrew L. Schirmer, Andover, MA (US)

Correspondence Address: CANTOR COLBURN LLP - IBM BOCA RATON, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/843,882

(22) Filed: Aug. 23, 2007

(51) Int. Cl. G06F 9/46

(52) U.S. Cl. 705/8

(57) ABSTRACT

A method for assisting a user in handling cascading event conflicts arising in a schedule provided by an electronic scheduling application includes receiving an indication of a first proposed event update to the schedule; determining whether the first proposed event update conflicts with any previously scheduled event; entering the first proposed event update into the schedule if the first proposed event update does not conflict; determining whether to select the first proposed event update or a first previously scheduled event for attempting to reschedule if the first proposed event update conflicts with the first previously scheduled event; determining whether to accept a second proposed event update for rescheduling of the selected one of the first proposed event update and the first previously stored event; and determining whether the second proposed event update conflicts with any previously scheduled event if the second proposed event update is accepted.

### TRADEMARKS

IBM® is a registered trademark of International Business Machines Corporation, Armonk, N.Y., U.S.A. Other names used herein may be registered trademarks, trademarks, or product names of International Business Machines Corporation or other companies.

### BACKGROUND OF THE INVENTION

1. Field of the Invention

This invention relates to electronic scheduling applications, and more particularly to the resolution of scheduling conflicts within an electronic scheduling application.

2. Description of Background

Many people rely on electronic scheduling or calendar applications in data processing systems to provide interactive assistance in scheduling future events (such as personal appointments, work meetings, family events, travel itineraries, etc.) by maintaining a calendar containing information about future events at entry points related to the times of the events. In addition to providing users with a way to view and manage individual daily schedules, an electronic calendar application may also allow a user to schedule meetings with other people also having their own individual electronic calendar applications. To schedule a meeting, a user may create and send invitations containing desired meeting information such as a requester name and any attendee whom the requester wishes to invite, as well as one or more proposed dates, times, and durations for the intended meeting. Recipients of meeting invitations can check their calendars to determine if they are available during the requested time period and either accept or reject the invitation. The electronic calendar application may also include scheduling features for manually accessing the electronic calendars of the requester and each of the potential attendees to view their free time periods in advance and determining the optimal dates, times, and durations for the intended meeting.

Oftentimes, there are situations that prevent a user from attending an event that the user has previously scheduled. For instance, an invitee may be compelled to accept a sudden invitation to a “more important” meeting that happens to coincide with the time of a “less important” meeting the invitee has already accepted. When such a situation arises for a user of current electronic calendar applications, the user must undertake a manual operation to clean up the conflict. The user does so by rescheduling or canceling the first scheduled event either before or after accepting the second schedule event. If the event is a meeting, the change may require notification of other potential attendees, which could result in negotiation with others and further rescheduling of the original meeting for a more optimal time. This, in turn, can cause additional conflicts for the user and potential attendees that can result in further rescheduling of other events in a cascading series of event changes, notifications, and negotiations. At each step, every individual involved must make choices about whether to accept or reject a proposed rescheduling in view of their own separate individual schedules. Moreover, if a proposed rescheduling eventually results in too many complications, it may be withdrawn. In this case, each potential attendee would need to “back up” in their chain of event rescheduling, which may then cause further cascading of events.

As is evident, such a series of cascading event rescheduling may involve a great deal of complication resulting from issues such as event interdependencies, deadlines, and flexibility, and therefore require the expenditure of much time and effort on the part of everyone involved. As a result of the confusion that can be caused by this complexity of interactions, many individuals can end up missing events they might otherwise attend or scheduling events at less than optimal times that cause others to miss the events.

### SUMMARY OF THE INVENTION

The shortcomings of the prior art can be overcome and additional advantages can be provided through exemplary embodiments of the present invention that are related to a method for assisting a user in handling cascading event conflicts arising in a schedule provided by an electronic scheduling application. The method comprises receiving an indication of a first proposed event update to the schedule; determining whether the first proposed event update conflicts with any previously scheduled event in the schedule; entering the first proposed event update into the schedule if the first proposed event update does not conflict with any previously scheduled event in the schedule; determining whether to select the first proposed event update or a first previously scheduled event in the schedule for attempting to reschedule if the first proposed event update conflicts with the first previously scheduled event; determining whether to accept a second proposed event update for rescheduling of the selected one of the first proposed event update and the first previously stored event; and determining whether the second proposed event update conflicts with any previously scheduled event in the schedule if the second proposed event update is accepted.

The shortcomings of the prior art can also be overcome and additional advantages can also be provided through exemplary embodiments of the present invention that are related to computer program products and data processing systems corresponding to the above-summarized method are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution that can be implemented to assist a user in rescheduling of one or more calendar events to resolve scheduling conflicts, including cascading scheduling conflicts, that may arise in the event of a calendar conflict with a newly proposed event. Because resolving one conflict may lead to another, exemplary embodiments can buffer change information while resolving all cascading conflicts sequentially in a way that is more efficient than current manual systems and in way that can lead to more optimal decisions by clarifying the consequences of each change in the event cascade to the user.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description of exemplary embodiments of the present invention taken in conjunction with the accompanying drawings in which:

FIG. 1 is a block diagram illustrating an exemplary embodiment of a system for managing network communications.

FIG. 2 is a flow diagram that illustrates a process for assisting a user in handling cascading event conflicts arising in an electronic scheduling application in accordance with an exemplary embodiment of the present invention.

FIG. 3 is a block diagram illustrating an exemplary embodiment of a hardware configuration for a computer system.

The detailed description explains exemplary embodiments of the present invention, together with advantages and features, by way of example with reference to the drawings. The flow diagrams depicted herein are just examples. There may be many variations to these diagrams or the steps (or operations) described therein without departing from the spirit of the invention. For instance, the steps may be performed in a differing order, or steps may be added, deleted, or modified. All of these variations are considered a part of the claimed invention.

### DETAILED DESCRIPTION OF EXEMPLARY EMBODIMENTS

While the specification concludes with claims defining the features of the invention that are regarded as novel, it is believed that the invention will be better understood from a consideration of the description of exemplary embodiments in conjunction with the drawings. It is of course to be understood that the embodiments described herein are merely exemplary of the invention, which can be embodied in various forms. Therefore, specific structural and functional details disclosed in relation to the exemplary embodiments described herein are not to be interpreted as limiting, but merely as a representative basis for teaching one skilled in the art to variously employ the present invention in virtually any appropriate form. Further, the terms and phrases used herein are not intended to be limiting but rather to provide an understandable description of the invention.

Exemplary embodiments of the present invention disclosed herein are directed to a process for resolving conflicts arising within an electronic calendar or scheduling application by assisting the user in rescheduling or moving one or more conflicting events. Exemplary embodiments can be implemented to handle both individual and group event conflicts, as well as both events initiated by the user herself and by other requesters. Exemplary embodiments can be implemented to assist a user running an electronic calendar application locally on a personal computer system for personal scheduling, as well as a user running an electronic calendar application on a networked computer system for scheduling group events with other users connected to the network in a multi-user environment. In addition to assisting the user in rescheduling events, exemplary embodiments can assist the user in making any other suitable decision that may be offered within electronic calendar applications such as, for example, accepting, rescheduling, canceling, countering, declining, and delegating meetings, as well as the option to reschedule or cancel all individual events of a specified type (for example, in the case of conflicts involving recurring events).

Because the resolution of one conflict may have the effect of introducing a conflict with another previously scheduled event, or a series of cascading conflicts between rescheduled events and previously scheduled events, exemplary embodiments can be implemented to assist the user in sequentially resolving all conflicts in a cascade of event conflicts in a manner that entails much less work than a manual process of user decisions and presents details of the consequences of each potential decision to the user. Furthermore, exemplary embodiments can be implemented to buffer the results of a series of decisions made by the user to allow the user to sequentially “unwind” the decision process. Hence, in situations in which the decision process for a series of cascading events leads to a “dead end”, that is, a result that the user does not like, the user can have the option to move back to any point in the process and resume decision making at that point to reach a different, more preferred resolution path.

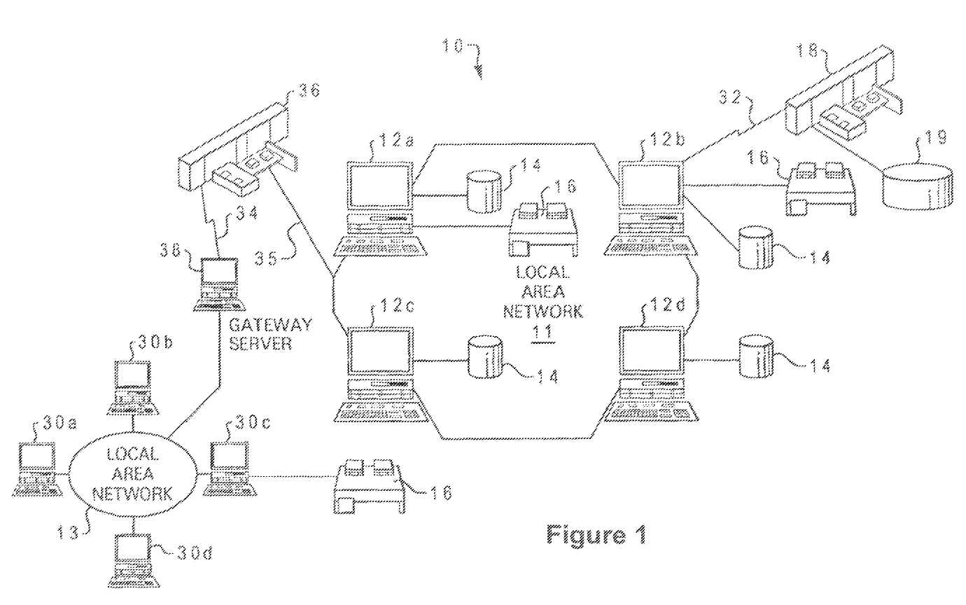

Turning now to the drawings in greater detail, it will be seen that FIG. 1 illustrates a system diagram of an exemplary computer network in which exemplary embodiments of the present invention may be implemented. As illustrated, a computer network 10 includes a local-area network 11 and a local-area network 13. Local-area networks 11 and 13 include computers 12a-12d and 30a-30d, respectively. Each of computers 12a-12d and 30a-30d may be coupled to a storage device 14 and/or an output device 16. Storage devices 14 can be utilized to store various documents or software applications that may be personal to a user of an individual computer within computer network 10.

Computer network 10 also includes several mainframe computers, such as mainframe computers 18 and 36. Mainframe computer 18 is coupled to local-area network 11 by means of a communications link 32. Mainframe computer 18 is also coupled to a storage device 19 that serves as remote storage for local-area network 11. Mainframe computer 36 is coupled to local-area network 11 by means of a communications link 35. Mainframe computer 36 is also coupled to local-area network 13 by means of a communications link 34 and a gateway server 38. Gateway server 38 is preferably a computer or an intelligent workstation that serves to link local-area network 11 to local-area network 13.

In the present exemplary embodiment, computer network 10 also includes an electronic calendar application. The electronic calendar application preferably allows individual users, who may use individual computers within computer network 10, to maintain individual electronic calendars on computer network 10. Individual electronic calendars may also be maintained on computer network 10 for physical assets such as conference rooms. Each individual electronic calendar can accept individual electronic calendar events, and each of the accepted events may include a start date/time and either a stop time or duration of the event on a particular day or days. Each electronic calendar event may also include information describing the location and notes about other details of the scheduled event.

In exemplary embodiments, the electronic calendar application can be implemented as a graphical user interface (GUI), which allows a user to interact with the application on a computer terminal through graphical icons and visual indicators or special graphical elements called “widgets,” along with text, labels, or text navigation to represent the information and actions available to the user. The actions are usually performed through direct manipulation of the graphical elements in response to control sequences such as keystrokes with the computer keyboard and movements of the computer mouse the user performs to control the application.

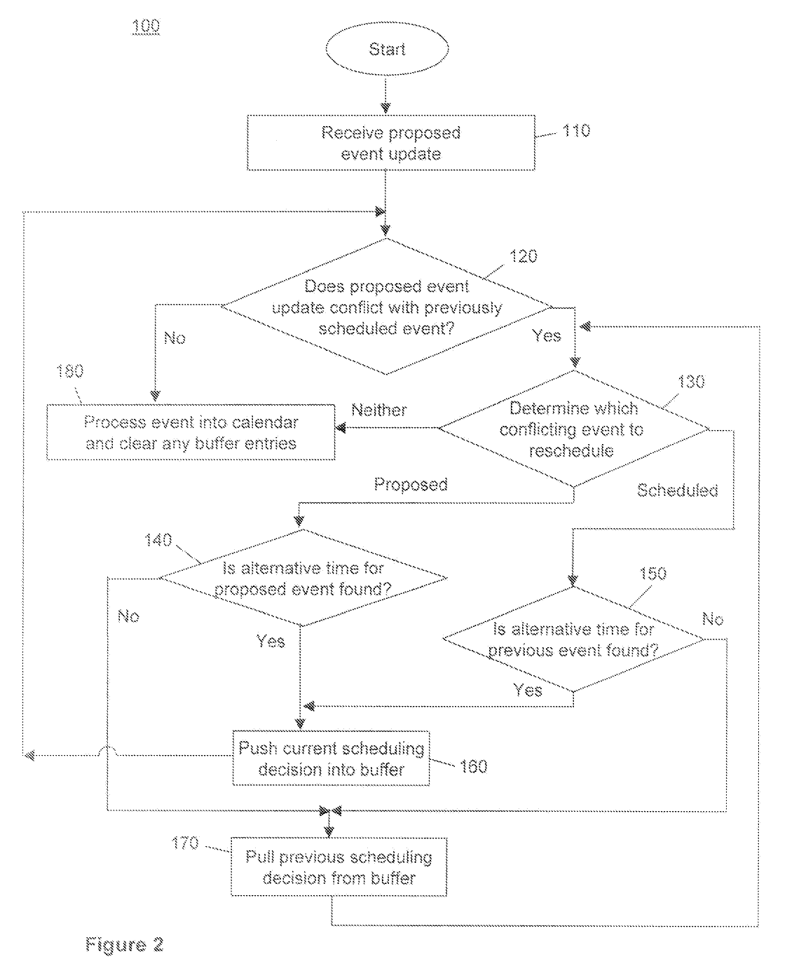

With reference now to FIG. 2, there is illustrated a high-level logic flow diagram of a process, indicated generally at 100, for resolving meeting conflicts within an electronic calendar application, in accordance with a exemplary embodiment of the present invention. Starting at block 110, a calendar application being run by a user receives notification of a new or changed calendar event for processing. The calendar event can be received by the application as, for example, a new event initiated by the user, a new event initiated by another requestor, a user-initiated change to a user-requested event, a user-initiated change to an event initiated by another requestor, a change initiated by another to a user-requested event, a change initiated by another to an event requested by another, a user-initiated cancellation of user-requested event, a cancellation initiated by another of an event requested by another, etc.

Upon receiving the proposed scheduling update information, a GUI within the electronic calendar application can alert the user that the scheduling update has been received and cause the scheduling update information to appear on a display together with the scheduling information stored in the computer system memory that is allocated for the application of the state of the calendar prior to receiving the proposed update. In exemplary embodiments, the application can be configured to query the user as to whether the user wishes to accept the event update, reject the event update, or, in the case of an event cancellation, propose an alternative event period to another requester. If the user chooses to reject the event update, it is discarded, and the process will terminate, as no new event scheduling information will need to be processed into the calendar. Similarly, the process will terminate if the event update is a cancellation of a previously scheduled event. If the user chooses to propose an alternative event period for the cancelled event, the process will initiate again, this time with notification of the proposed alternative event period being received as the event update at block 110.

After notification of an event update having new event scheduling information for processing is received, process 100 proceeds to decision block 120, at which a determination is made as to whether the proposed event update conflicts with an event already stored in the calendar. If no scheduling conflict is found, the scheduling update is entered into calendar at block 180, and the process terminates. If a conflict exists, the GUI can display an indication of the conflict to the user, and a determination must be made of whether to replace the previously scheduled event with the proposed update. For example, the proposed update information can appear on the left side of a split screen showing the date of the proposed meeting, the time and place, as well as the individual or group with whom the meeting is proposed, and the previously scheduled event for the same time period as the proposed update can appear on the right side of the split screen.

In certain situations, the user may choose not to resolve the conflict and keep both events as currently scheduled, and the process terminates until initiated by the user or within the process. Otherwise, a determination is made as to whether to replace the previously scheduled event with the proposed update at decision block 130. In exemplary embodiments, the user by may make the choice manually by, for example, inspecting the calendar, the conflicting event, and other information presented to the user within the GUI. In alternative exemplary embodiments, the choice may be made automatically by the application according preset rules for resolving conflicts. The preset rules can, for example, be based upon user-specified preferences such as the relative importance of subject matter underlying the event, relative priority specified for specific events, how prepared the user will be for the event at the proposed time, and timing considerations (for example, whether the user prefers to have events scheduled adjacently). In other alternative exemplary embodiments, the choice may be made using a hybrid approach that combines manual and automatic decision making. The determination can be made in any number of suitable ways in accordance with exemplary embodiments of the present invention.

If the user chooses to keep the existing event, a determination of an alternative time for which the proposed event is made at decision block 140. As above, this determination can be made using, for example, manual, automatic, or manual and automatic means, and the determination can be made in any number of suitable ways in accordance with exemplary embodiments of the present invention. If the decision is made manually, the user can access the calendar to determine available rescheduling times. In exemplary embodiments, the application can propose a number of available rescheduling times, display an indication of the consequences of accepting each one for comparison (for example, the cost information for each alternative time in terms of others that might potentially attend the event and the effect of cascading reschedules of events on both the user and others to provide the user with alternative or additional metrics for making the decision about which path to choose), and allow the user to select one of the proposed rescheduling times. In the exemplary embodiments, proposed alternatives can be limited by different conditions, including, but not limited to, the number of events that must be changed. In exemplary embodiments, the alternatives times that are proposed can be selected by other systems. If the user instead chooses to keep the new event, the information necessary to process that new event is recorded, the existing event becomes the new event, and a determination of an alternative time for which the previous event is made at decision block 150 in the same manner as with the proposed event at decision block 140.

If an acceptable new time for the event has been found at decision block 140 or decision block 150, the information for processing it is recorded at block 160. Because the resolution of one conflict may have the effect of introducing another conflict or a series of cascading conflicts, exemplary embodiments can be implemented to temporarily store the results of a series of decisions made by the user in a decision buffer at block 160 to allow the user to sequentially “unwind” the decision process, as will be described.

In exemplary embodiments, the decision buffer can be implemented as a counter and a region of memory used to temporarily hold data for each decision sequentially in an input stack while it is being processed. Data is read in from one source, and then written to another, as the sources are ready to receive or send data. In exemplary embodiments, the buffer can be implemented in either hardware or software, and the buffer can use, for example, a LIFO (last in, first out) method, outputting data of each decision in the opposite order in which it was received. The counter is incremented whenever data of a new decision is pushed onto the stack, and the counter is decremented whenever data of a previous decision is pulled from the stack.

After a selection is processed at block 160, process 100 returns to decision block 120, where it checks the new time and date of the rescheduled event against the calendar to determine if the new event update conflicts with another event already stored in the calendar. If no scheduling conflict is found, the scheduling update is entered into calendar at block 180, the process terminates, the calendar update is completed, and the buffer can be cleared. If a new scheduling conflict is found, the resolution process continues to decision block 130 as described above. Thus, in exemplary embodiments, the rescheduling of any particular event may lead to a chain calling for the rescheduling of one or more other events in a cascade of conflicts. In these instances, the data of each decision is sequentially stored into the decision buffer, and the counter is incremented with each stored decision.

In exemplary embodiments, if an acceptable new time for the event was not found at decision block 140 or decision block 150, the user can be presented with the opportunity to dispense with the event at block 170 in any suitable manner afforded by schedulers, such as by delegating or rejecting the event, and thereby terminating the process. In exemplary embodiments, dispensing of events by, for example, delegation and rejection, might be allowed in a fully automated embodiment in which the necessary rules are in place.

In exemplary embodiments, the user can also be presented with the option of checking the calendar again for a suitable time, or, failing that, proceeding to block 170 to move back to the previous decision in the process by pulling the previous decision, if one had made, from the decision buffer. This act of retracting a decision essentially discards the previous decision, if any, and allows the user make a new decision about that event. This affords the user with flexibility in handling a set of cascading conflicts to account for situations in which the decision process for a series of cascading events leads to a “dead end,” that is, a result that the user does not like. The user is permitted to sequentially move back to any rescheduling decision and resume decision making at decision block 130 in an attempt to reach a different, more preferable resolution path. The process avoids having to retract such revisions from the scheduling calendar by holding the results of all decision information in a buffer until all conflicts have been resolved and the process terminates, at which point all decision can be processed into the calendar in the manner of the particular calendar application.

In exemplary embodiments, the application can process each decision in the calendar immediately, rather than waiting until all conflicts have been resolved. This could be of value in situations where, for example, it is important to book a meeting as soon as possible. In exemplary embodiments, the user can be presented with the option to choose whether to have each decision immediately processed in the calendar, rather than having each decision processed automatically.

As discussed above, the decisions at each step in the process can be made in any number of suitable ways in accordance with exemplary embodiments of the present invention. In exemplary embodiments, the user by may make the choices manually by, for example, inspecting the calendar, the conflicting event, and other information presented to the user within the GUI.

In alternative exemplary embodiments, the choice may be made automatically by the application according preset rules for resolving conflicts. In some exemplary embodiments, the user, upon being presented with a choice, may elect to trust the application's calculated selection of a best scenario for rescheduling cascading events and have the choices applied automatically. In exemplary embodiments, the application can notify the user of the decisions that were made automatically.

In other alternative exemplary embodiments, the choice may be made using a hybrid approach that combines manual and automatic decision making. In these exemplary embodiments, the application can propose a number of available rescheduling times and options for fitting events into the calendar, display an indication of the consequences of accepting each one for comparison by calculating complete solutions for varying cascades of events that may occur (for example, the cost information for each alternative time in terms of others that might potentially attend the event and the effect of cascading reschedules of events on both the user and others can be displayed to provide the user with alternative or additional metrics for making the decision about which path to choose), and allow the user to select one of the proposed rescheduling times.

Exemplary embodiments of the present invention may be implemented using any suitable GUI techniques such as, for example, direct manipulation of the calendar display, modal windows providing for dialog boxes, terminal windows, wizards, etc. In a direct manipulation interface, the user could, for example, drag an event to an occupied time slot on the calendar, causing the process to initiate and move one of the conflicting events to another other slot according to user decisions, pre-set rules, or a combination thereof. Exemplary embodiments of the present invention may be implemented as part of the calendar application's GUI to display the process and results of making decisions.

Exemplary embodiments of the present inventions may be implemented within any suitable electronic scheduling application. For instance, exemplary embodiments can be implemented within calendaring and scheduling tools that are included in management software packages such as Now Up-to-Date & Contact Novell GroupWise, Netscape Communicator, ContactOffice, The Calendar Planner, Microsoft Exchange, Google Calendar, and in Vue. Exemplary embodiments can also be implemented within calendaring and scheduling tools that may be included in other forms of collaboration software, calendaring and messaging applications, group product calendars, enterprise calendars, event scheduling systems, etc. Exemplary embodiments may also be implemented as auxiliary add-on modules that may be incorporated as a separate component into a calendar application to extend the application's capabilities to provide functionality for resolving cascading event conflicts. For example, the functionality for resolving cascading event conflicts can be incorporated either as an extension that provides for its own user interface or a plug-in that generally relies on the host calendar application's user interface.

The capabilities of exemplary embodiments of present invention described above can be implemented in software, firmware, hardware, or some combination thereof, and may be realized in a centralized fashion in one computer system, or in a distributed fashion where different elements are spread across several interconnected computer systems. Any kind of computer system—or other apparatus adapted for carrying out the methods and/or functions described herein—is suitable. A typical combination of hardware and software could be a general purpose computer system with a computer program that, when being loaded and executed, controls the computer system such that it carries out the methods described herein. Exemplary embodiments of the present invention can also be embedded in a computer program product, which comprises features enabling the implementation of the methods described herein, and which—when loaded in a computer system—is able to carry out these methods.

Computer program means or computer program in the present context include any expression, in any language, code or notation, of a set of instructions intended to cause a system having an information processing capability to perform a particular function either directly or after conversion to another language, code or notation, and/or reproduction in a different material form.

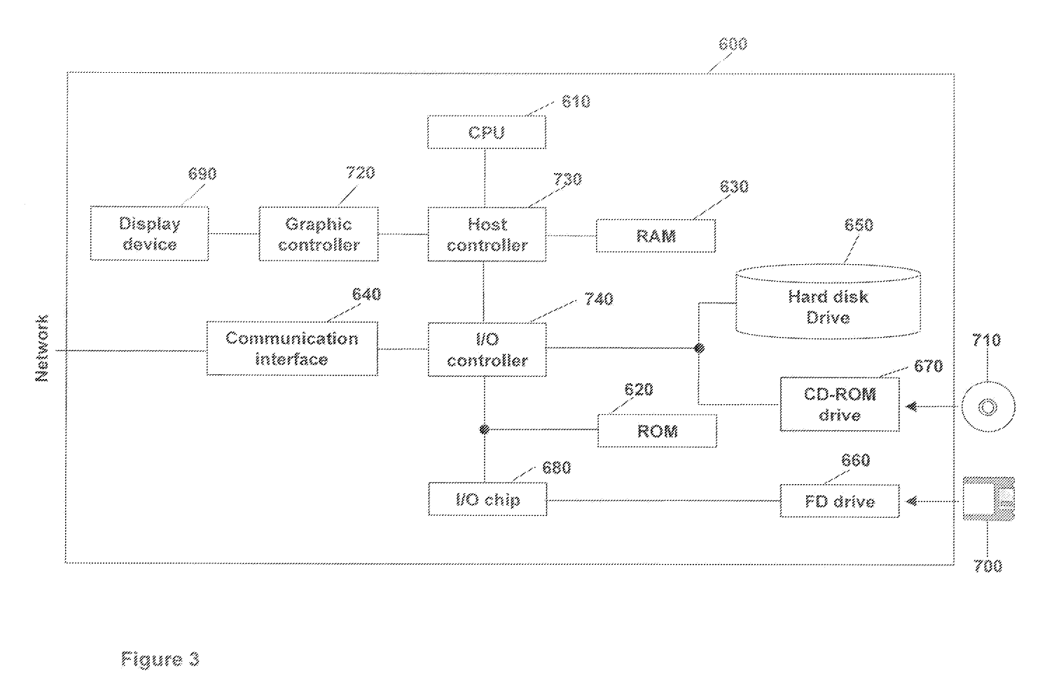

Therefore, one or more aspects of exemplary embodiments of the present invention can be included in an article of manufacture (for example, one or more computer program products) having, for instance, computer usable media. The media has embodied therein, for instance, computer readable program code means for providing and facilitating the capabilities of the present invention. The article of manufacture can be included as a part of a computer system or sold separately. Furthermore, at least one program storage device readable by a machine, tangibly embodying at least one program of instructions executable by the machine to perform the capabilities of the exemplary embodiments of the present invention described above can be provided. To illustrate, FIG. 3 shows a block diagram of an exemplary embodiment of a hardware configuration for a computer system, representing one of computer systems 12a-12b and 30a-30b in FIG. 1, and through which exemplary embodiments of the present invention can be implemented.

As illustrated in FIG. 3, computer system 600 includes: a CPU peripheral part having a CPU 610 that accesses a RAM 630 at a high transfer rate, a display device 690, and a graphic controller 720, all of which are connected to each other by a host controller 730; an input/output part having a communication interface 340, a hard disk drive 650, and a CD-ROM drive 670, all of which are connected to host controller 730 by an input/output controller 740; and a legacy input/output part having a ROM 620, a flexible disk drive 660, and an input/output chip 680, all of which are connected to input/output controller 740.

Host controller 730 connects RAM 630, CPU 610, and graphic controller 720 to each other. CPU 610 operates based on programs stored in ROM 620 and RAM 630, and controls the respective parts. Graphic controller 720 obtains image data created on a frame buffer provided in RAM 630 by CPU 610 and the like, and displays the data on the display device 690. Alternatively, graphic controller 720 may include a frame buffer that stores image data created by CPU 610 and the like therein.

Input/output controller 740 connects host controller 730 to communication interface 640, hard disk drive 650, and CD-ROM drive 670, which are relatively high-speed input/output devices. Communication interface 640 communicates with other devices through the network. Hard disk drive 650 stores programs and data that are used by CPU 610 in computer 600. CD-ROM drive 670 reads programs or data from CD-ROM 710 and provides the programs or the data to hard disk drive 650 through RAM 630.

Moreover, ROM 620, flexible disk drive 660, and input/output chip 680, which are relatively low-speed input/output devices, are connected to input/output controller 740. ROM 620 stores a boot program executed by computer 600 at its start, a program dependent on the hardware of the computer, and the like. Flexible disk drive 660 reads programs or data from flexible disk 700 and provides the programs or the data to hard disk drive 650 through RAM 630. Input/output chip 680 connects the various input/output devices to each other through flexible disk drive 660 and, for example, a parallel port, a serial port, a keyboard port, a mouse port and the like.

The programs provided to hard disk drive 650 through RAM 630 are stored in a recording medium such as flexible disk 700, CD-ROM 710, or an IC card. Thus, a user can provide the programs. The programs are read from the recording medium, installed into hard disk drive 650 in computer 600 through RAM 630, and executed in CPU 610.

The above-described program or modules implementing exemplary embodiments of the present invention can work on CPU 610 and the like to assist a user in rescheduling one or more calendar events to resolve scheduling conflicts, including cascading scheduling conflicts, that may arise in the event of a calendar conflict with a newly proposed event. The program or modules implementing exemplary embodiments may be stored in an external storage medium. In addition to flexible disk 700 and CD-ROM 710, an optical recording medium such as a DVD and a PD, a magneto-optical recording medium such as a MD, a tape medium, a semiconductor memory such as an IC card, and the like may be used as the storage medium. Moreover, the program may be provided to computer 600 through the network by using, as the recording medium, a storage device such as a hard disk or a RAM, which is provided in a server system connected to a dedicated communication network or the Internet.

Although exemplary embodiments of the present invention have been described in detail, it should be understood that various changes, substitutions and alternations can be made therein without departing from spirit and scope of the inventions as defined by the appended claims. Variations described for exemplary embodiments of the present invention can be realized in any combination desirable for each particular application. Thus particular limitations, and/or embodiment enhancements described herein, which may have particular advantages to a particular application, need not be used for all applications. Also, not all limitations need be implemented in methods, systems, and/or apparatuses including one or more concepts described with relation to exemplary embodiments of the present invention.

While exemplary embodiments of the present invention have been described, it will be understood that those skilled in the art, both now and in the future, may make various modifications without departing from the spirit and the scope of the present invention as set forth in the following claims. These following claims should be construed to maintain the proper protection for the present invention.

What is claimed is:

1. A method for assisting a user in handling cascading event conflicts arising in a schedule provided by an electronic scheduling application, the method comprising:
receiving an indication of a first proposed event update to the schedule;
determining whether the first proposed event update conflicts with any previously scheduled event in the schedule;
entering the first proposed event update into the schedule if the first proposed event update does not conflict with any previously scheduled event in the schedule;
determining whether to select the first proposed event update or a first previously scheduled event in the schedule for attempting to reschedule if the first proposed event update conflicts with the first previously scheduled event;
determining whether to accept a second proposed event update for rescheduling of the selected one of the first proposed event update and the first previously stored event; and
determining whether the second proposed event update conflicts with any previously scheduled event in the schedule if the second proposed event update is accepted.

2. The method of claim 1, further comprising:
entering the second proposed event update into the schedule if the second proposed event update does not conflict with any previously scheduled event in the schedule;
determining whether to select the second proposed event update or a second previously scheduled event in the schedule for attempting to reschedule if the second proposed event update conflicts with the second previously scheduled event;
determining whether to accept a third proposed event update for rescheduling of the selected one of the second proposed event update and the second previously stored event; and
determining whether the third proposed event update conflicts with any previously scheduled event in the schedule if the third proposed event update is accepted.

3. The method of claim 2, further comprising:
pushing an indication of the first proposed event update and the first previously stored event onto a stack if the second proposed event update is accepted;
pushing an indication of the second proposed event update and the second previously stored event onto the stack if the third proposed event update is accepted; and
pulling the indication of the first proposed event update and the first previously stored event from the stack if the third proposed event update is not accepted.

4. The method of claim 3, wherein if the third proposed event update is not accepted, the method further comprises:
determining whether to select the first proposed event update or the first previously scheduled event in the schedule for attempting to reschedule;
determining whether to accept a fourth proposed event update for rescheduling of the selected one of the first proposed event update and the first previously stored event; and
determining whether the fourth proposed event update conflicts with any previously scheduled event in the schedule.

5. The method of claim 3, wherein if the second proposed event update is accepted and the second proposed event update does not conflict with any previously scheduled event in the schedule, the method further comprises:
pulling the indication of the first proposed event update and the first previously stored event from the stack; and
entering the non-selected one of the first proposed event update and the first previously stored event into the schedule.

6. The method of claim 3, wherein if the third proposed event update is accepted and the third proposed event update does not conflict with any previously scheduled event in the schedule, the method further comprises:
entering the third proposed event update into the schedule;
pulling the indication of the second proposed event update and the second previously stored event from the stack;
entering the non-selected one of the second proposed event update and the second previously stored event into the schedule;
pulling the indication of the first proposed event update and the first previously stored event from the stack; and
entering the non-selected one of the first proposed event update and the first previously stored event into the schedule.

7. The method of claim 1, further comprising entering the non-selected one of the first proposed event update and the first previously scheduled event if the second proposed event update is accepted.

8. The method of claim 2, further comprising entering the non-selected one of the second proposed event update and the second previously scheduled event if the third proposed event update is accepted.

9. The method of claim 1, wherein determining whether to select the first proposed event update or a first previously scheduled event in the schedule further comprises enabling the user to select neither and delegate or reject the event.

10. The method of claim 1, wherein the indication of the first proposed event update is one of a new event initiated by the user, a new event initiated by another requester, a change initiated by the user to an event requested by the user, a change initiated by the user to an event requested by another requester, a change initiated by another to an event requested by the user, a change initiated by another to an event requested by another, a cancellation initiated by the user to an event requested by the user, and a cancellation initiated by another of an event requested by another.

11. The method of claim 1, wherein the user is enabled to manually make the determinations of whether to select the first proposed event update or the first previously scheduled event and whether to accept the second proposed event update for rescheduling.

12. The method of claim 11, wherein the user is enabled to manually propose the second proposed event update.

13. The method of claim 11, wherein the application is configured to automatically propose one or more potential event updates for the second proposed event update, and wherein the user is enabled to manually select one of the one or more potential event updates as the second proposed event update.

14. The method of claim 13, wherein the application if configured to calculate and provide an indication of the consequences of accepting each of the one or more potential event updates to the user.

15. The method of claim 1, wherein the application is configured to automatically make the determinations of whether to select the first proposed event update or the first previously scheduled event and whether to accept the second proposed event update for rescheduling.

16. A computer-usable medium having computer readable instructions stored thereon for execution by a processor to perform a method for, the method comprising:
receiving an indication of a first proposed event update to the schedule;
determining whether the first proposed event update conflicts with any previously scheduled event in the schedule;
entering the first proposed event update into the schedule if the first proposed event update does not conflict with any previously scheduled event in the schedule;
determining whether to select the first proposed event update or a first previously scheduled event in the schedule for attempting to reschedule if the first proposed event update conflicts with the first previously scheduled event;
determining whether to accept a second proposed event update for rescheduling of the selected one of the first proposed event update and the first previously stored event; and
determining whether the second proposed event update conflicts with any previously scheduled event in the schedule if the second proposed event update is accepted.

17. The computer-usable medium of claim 16, wherein the method further comprises:
entering the second proposed event update into the schedule if the second proposed event update does not conflict with any previously scheduled event in the schedule;
determining whether to select the second proposed event update or a second previously scheduled event in the schedule for attempting to reschedule if the second proposed event update conflicts with the second previously scheduled event;
determining whether to accept a third proposed event update for rescheduling of the selected one of the second proposed event update and the second previously stored event; and
determining whether the third proposed event update conflicts with any previously scheduled event in the schedule if the third proposed event update is accepted.

18. A data processing system comprising:
a central processing unit;
a random access memory for storing data and programs for execution by the central processing unit;
a first storage level comprising a nonvolatile storage device; and
computer readable instructions stored in the random access memory for execution by central processing unit to perform a method for, the method comprising:
receiving an indication of a first proposed event update to the schedule;
determining whether the first proposed event update conflicts with any previously scheduled event in the schedule;
entering the first proposed event update into the schedule if the first proposed event update does not conflict with any previously scheduled event in the schedule;
determining whether to select the first proposed event update or a first previously scheduled event in the schedule for attempting to reschedule if the first proposed event update conflicts with the first previously scheduled event;
determining whether to accept a second proposed event update for rescheduling of the selected one of the first proposed event update and the first previously stored event; and
determining whether the second proposed event update conflicts with any previously scheduled event in the schedule if the second proposed event update is accepted.

19. The data processing system of claim 18, wherein the method further comprises:
entering the second proposed event update into the schedule if the second proposed event update does not conflict with any previously scheduled event in the schedule;
determining whether to select the second proposed event update or a second previously scheduled event in the schedule for attempting to reschedule if the second proposed event update conflicts with the second previously scheduled event;
determining whether to accept a third proposed event update for rescheduling of the selected one of the second proposed event update and the second previously stored event; and
determining whether the third proposed event update conflicts with any previously scheduled event in the schedule if the third proposed event update is accepted.
